(19) United States
(12) Patent Application Publication
(10) Pub. No.: US 2001/0027487 A1
(43) Pub. Date: Oct. 4, 2001

(54) Network-based content collection and distribution system

(76) Inventors: Karl Ruping, Cambridge, MA (US); Wei Shi, Brighton, MA (US); Xuejun Wang, Malden, MA (US)

Correspondence Address: Karl Ruping, 87 Cherry St, Cambridge, MA, 02139, US

(21) Appl. No.: 09/728,221

(22) Filed: Nov. 30, 2000

Related U.S. Application Data
(60) Provisional application No. 60/168,180, filed on Nov. 30, 1999.

(51) Int. Cl. G06F 15/16; G06F 15/173

(52) U.S. Cl. 709/229; 709/244

(57) ABSTRACT

The invention collection of mail content in digital form and delivers of the mail content in hardcopy form over a distribution system that pushes the processing of the physical mail to a location close to the recipient's geographical address. A sender composes a mail item in digital form and the invention then distributes the digital content through a three tier model. The first tier accepts the digital content from the sender, verifies the identity of the sender, and prepares the digital content for presentation to the next tier. The second tier is a management point on the transmission network that determines the closest available processing location based on the geographical address of the recipient. The third tier consists of two or more processing locations that accept the digital content from the earlier tier, processes the digital content into hardcopy form, and presents the hardcopy content to a physical delivery system such as a postal service or commercial courier. Unlike the prior art of mapping a network addresses to a network addresses or mapping geographical addresses to geographical addresses, the invention maps the recipient's geographical address to a network address of a processing location. Thus, the physical delivery begins not from the digital content origin, which may be distant from the final destination, but from the available processing location that is closest to the recipient's geographical address.

### CROSS-REFERENCE TO RELATED APPLICATIONS

### BACKGROUND

1. Field of Invention

This invention relates to a computer network system, specifically a system that collects digital content and processes the content into hardcopy form. This application is entitled to the benefit of Provisional Patent Application Ser. No. 60/168,180 filed on Nov. 30, 1999.

2. Prior Art

The processing and distribution of mail content was originally by means of processing at, and mailing from, the sender's single location to the recipient's address over the postal system or a commercial courier. For mass mail content it was left to the postal or courier system to determine the delivery routes from the sender to the multiple recipient addresses. For both, the physical delivery system faced expensive collection and transportation costs, and the recipient faced growing time delays when the mail content had to physically travel long distances.

To reduce this delay, some companies with multiple offices would process and mail content at the office responsible for the recipient's account. But this was not necessarily the closest processing location relative to the recipient's address or relative to the postal system's or commercial courier's distribution network. Further, the processing at multiple locations was not an integrated system.

Some logistics companies process the mail content of various clients at a central location or several satellite processing locations. This centralization of mail processing and delivery, however, was sometimes even less efficient in terms of distance from the recipient. For example, a mailing for a recipient's local cable TV service in Florida may come from an Oregon processing center.

With the advent of the Internet, mail content could be directly presented to the receiver, completely avoiding a physical delivery system. However, many recipients are without Internet access and other recipients do not want to access content in digital form alone.

More recently electronic letter websites, such as eLetter, allow senders to compile a letter and send it over the Internet to a central mailing location where it is processed and submitted to the postal system for physical delivery to the receiver. This, however, does not allow for mass mailings, multiple processing locations, or efficient mailing based on the recipient's location.

A further limitation of the prior art is that physical distribution matches the geographic address of the distribution point or points with the geographical address of the recipient. Similarly, electronic distribution matches the network address of the distribution point or points with the network address of the recipient.

### SUMMARY

The claimed invention enables the collection of mail content in digital form from the sender and the delivery of the mail content in hardcopy form over a distribution system that pushes the processing of the physical mail to a location close to the recipient's geographical address.

A sender composes a mail item in digital form and the invention then distributes the digital content through a three tier model. The first tier accepts the digital content from the sender, verifies the identity of the sender, and prepares the digital content for presentation to the next tier. The second tier is a management point on the transmission network that determines the closest available processing location based on the geographical address of the recipient. The third tier consists of two or more processing locations that accept the digital content from the earlier tier, processes the digital content into hardcopy form, and presents the hardcopy content to a physical delivery system such as a postal service or commercial courier.

Unlike the prior art of mapping a network addresses (e.g. internet IP addresses) to a network addresses or mapping geographical addresses (e.g. postal addresses) to geographical addresses, the invention maps the recipient's geographical address to a network address of a processing location. Thus, the physical delivery begins not from the digital content origin, which may be distant from the final destination, but from the available processing location that is closest to the recipient's geographical address.

We envision one likely application to be the collection and distribution of print content, such as a letter. The sender transmits a letter in digital form to the invention where it is propagated to the nearest processing location where it is automatically printed, addressed, folded, and stamped before being delivered to the intended recipient through a physical delivery system such as the traditional postal system or courier. Other applications may be a music, movie or software distribution service where the content is sent initially over the network and then processed in a location closest to the intended recipient for the final leg of physical distribution.

### OBJECTS AND ADVANTAGES

Accordingly, several objects and advantages of this invention are:

(a) an integrated system of mailing content across a digital network, such as the Internet, and across a physical delivery network such as the postal system;

(b) an express mail system where digital content is sent to the nearest processing point for final delivery to the recipient which reduces mail delivery time;

(c) a mail distribution system which reduces the amount of human handling, physical transportation distance relative to traditional mail, and thus reduces the risk of loss or interference in the distribution of such content;

(d) a joint digital distribution—physical delivery system which can be an addition to an electronic mail system to serve recipients lacking internet access;

(e) a mailing system which uses a digital collection element rather than a physical collection element at the mail content origin, thus saving transportation costs, and overall mailing time.

(f) an address mapping system which maps a geographical address to a network address which identifies a location that is both on the network and geographically close to a particular address.

Further objects and advantages of this invention will become apparent from a consideration of the drawings and ensuing description.

### DESCRIPTION OF DRAWINGS

FIG. 1 A overview of the invention and its system elements.

FIG. 2(a) The Common Service Access Point which interfaces between the sender's browser or similar software interface and the Central Server

FIG. 2(b) The Special Service Access Point which interfaces between the sender's custom service interface and the Central Server.

FIG. 3. The system architecture of the Central Server.

FIG. 4. The system architecture of the Service Destination Agent.

FIG. 5. An example of a geographical address—network address routing table.

### REFERENCE NUMERALS IN DRAWINGS

1. Central Server

2. Service Destination Agent

3. Service Access Point

4. Network

5. Database

6. Server

7. Output Devices

10. Common Service Access Point

11. Web Server

12. Special Service Access Point

20. Send queue

21. Routing table

22. Format library

23. Database

24. Security

26. Web Server

27. prpd

28. dispatchd

29. sndd

30. rcptd

31. pstpd

32. sdad

33. diagd

34. prp_queue

35. dsp_queue

36. snd_queue

37. retry timer

38. rcpt timer

39. pst_ueue

40. Receive queue

41. Format library

42. Output device table

44. cntind

45. cntpd

46. outd

47. pstpd

48. csd

49. diagd

50. cnt_queue

51. outp_ueue

52. pst_queue

53. Security

60. Routing Table

### DESCRIPTION OF INVENTION

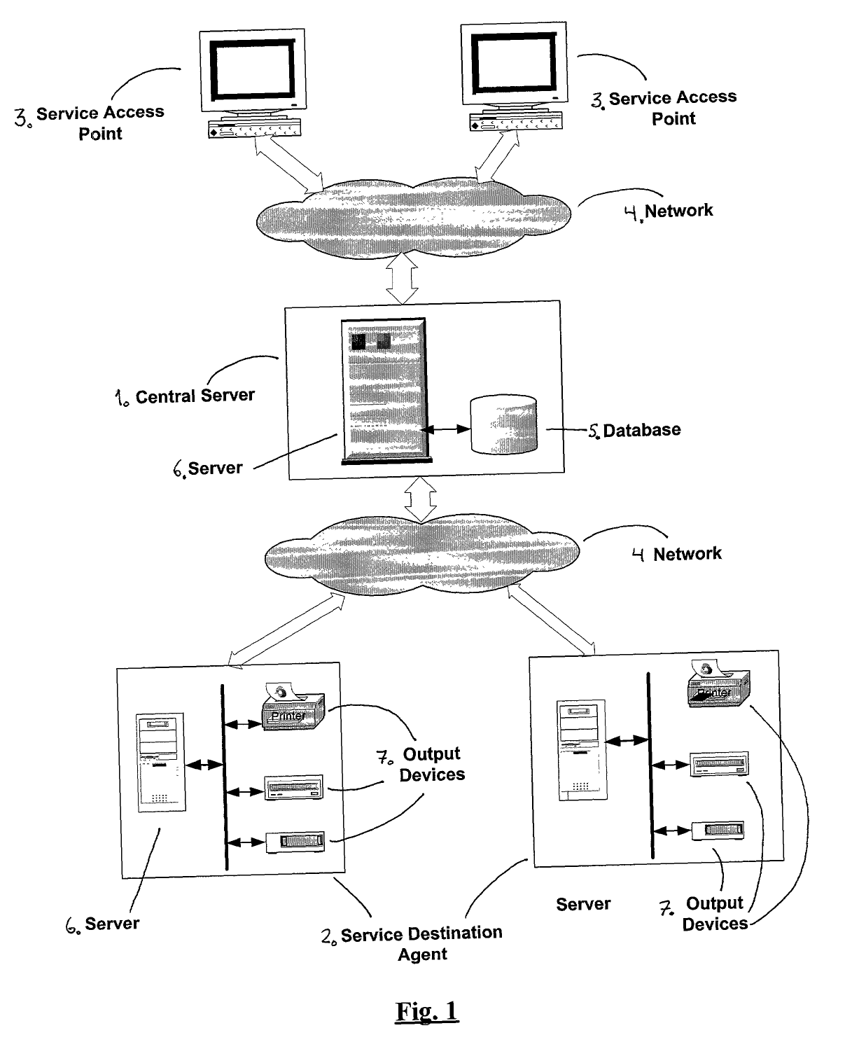

The invention consists of three tiers, each tier itself or together with a different tier being an invention. As shown in FIG. 1, Tier 1 is a Service Access Point 3, Tier 2 is a Central Server 1, and Tier 3 is two or more Service Destination Agents 2. These Tiers are connected by a network 4, such as but not limited to the Internet.

Tier 1. Service Access Point

Tier 1 is a Service Access Point 3. This is the interface through which the sender accesses the invention. The Service Access Point may be an Internet web browser, a client interface software application, or a similar interface.

The sender initially registers for services and provides the appropriate sender information through the Service Access Point. Senders can choose the format of the mail content, enter the destination address or select from a pre-defined address book, and upload or edit the content and related material such as common forms and saved files. The registered sender can also trace delivery status and account information by means of the Service Access Point interface with Tier 2.

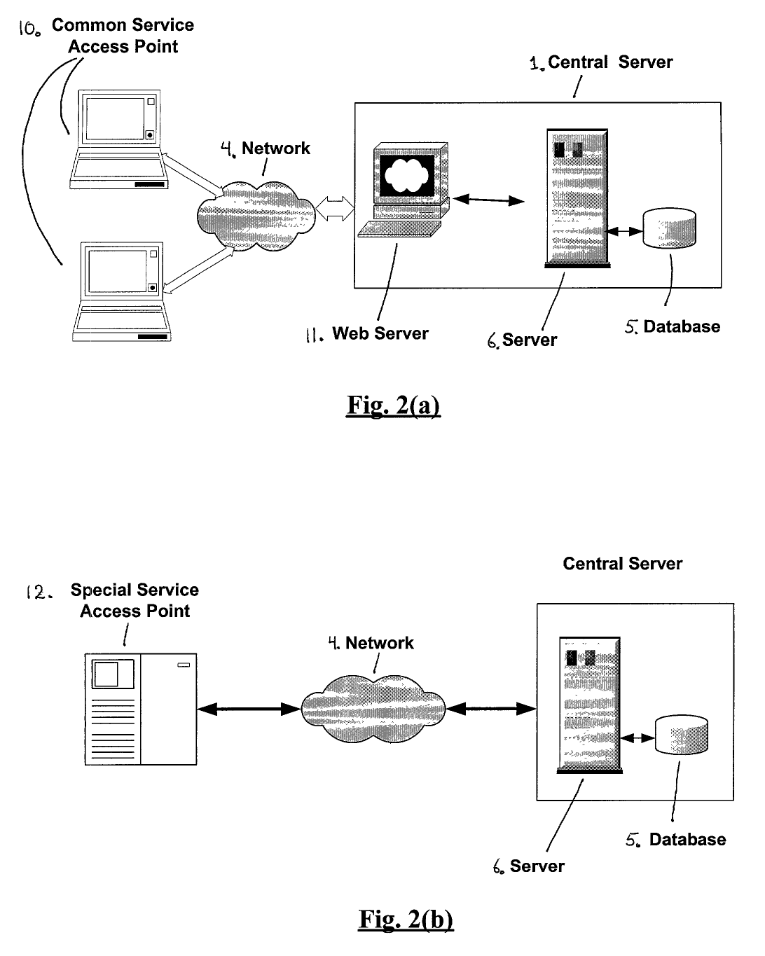

There are two types of Tier 1 interfaces. As shown in FIG. 2(a), Tier 1A as a Common Service Access Point 6 that is for the individual or low-volume sender. As shown in FIG. 2(b), Tier 1B is a Special Service Access Point 7 that is for the commercial or high-volume sender.

a. Tier 1A—Common Service Access Point

As shown in FIG. 2(a), the Common Service Access Point can be a standard web browser or similar interface through which the sender accesses a general web server 11 or similar interface on Tier 2. Among the functions available are:

Sign up for services.

Access and update account information.

Specify content format.

Create or edit address and content.

Enter address or select address from pre-defined address book.

Pre-view mail content and processing information before sending.

Upload data file.

Schedule future delivery.

Trace delivery status.

Choose security level

b. Tier 1B—Special Service Access Point

As shown in FIG. 2(b), Tier 1B is a Special Service Access Point 12. This is expected to be used by senders who have large amounts of material to send. Tier 1B is an application which implements all of the functions available in Tier 1B, namely:

Sign up for services.

Access and update account information.

Specify content format.

Create or edit address and content.

Enter address or select address from pre-defined address book.

Pre-view mail content and processing information before sending.

Upload data file.

Schedule future delivery.

Trace delivery status.

Choose security level

In addition the Special Service Access Point provides a custom designed interface that can be modified to meet the needs of a sender's particular back-office interface. Rather that a standard browser, for example, this may be a dedicated communications software application that converts the mail content of the sender to the format used by the other tiers. The connection between Special Service Access Point and Tier 2 can be a logical connection.

One example of a Tier 1B application is a credit card company that sends bills to multiple card holders. The volume is large, the data is different from each individual billing statement, but the format is generally the same. The address and content, which is likely to be encrypted, is transmitted through a dedicated connection once the billing data is generated by the sender's own system in real-time. The dedicated connection can be a TCP connection or some other connection-oriented or connectionless protocols.

Tier 2. Central Server

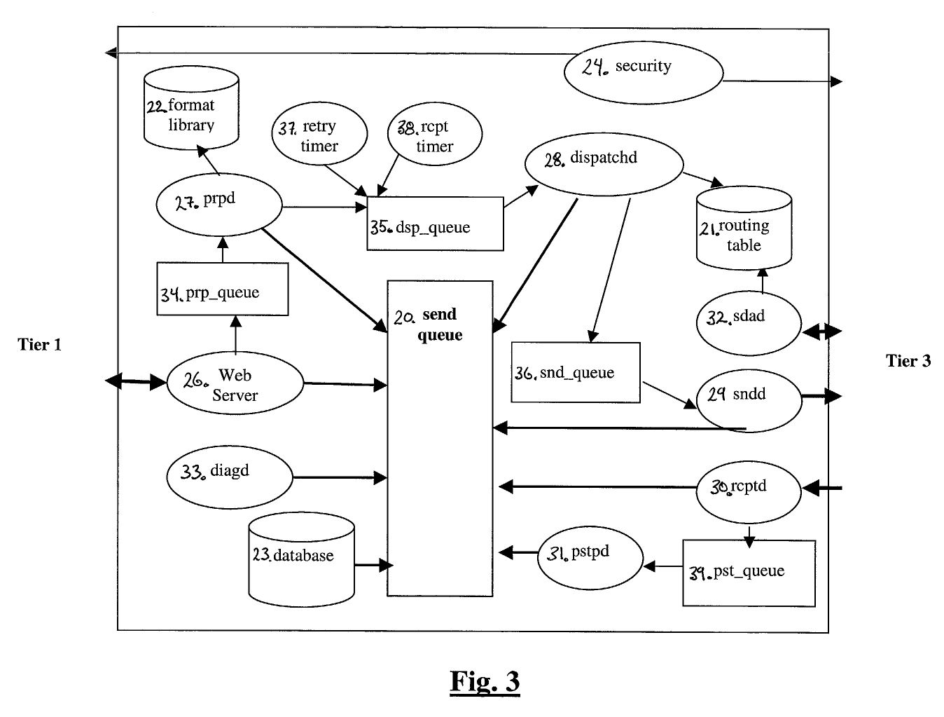

Tier 2 is a Central Server 1. As shown in FIG. 1, this is an Internet server 6 with database 5 access, or a similar configuration. As shown in FIG. 3, this is the general data collection and dispatch center of the invention. The Central Server receives data comprised of mail content, addresses and other processing data from Tier 1. The Central Server parses the data to obtain the recipient's address and related processing data, and determines the closest available processing location at Tier 3 according to the recipient's geographical address or other parameters.

The Central Server maps the network address of the closest available Service Destination Agent and the geographical address of the recipient. Geographical proximity to the recipient's address may be based on the country and the zip code, with appropriate geographical proximity default. For example, when the country code is not included in the destination address, the default is the country code of the registered sender.

The Central Server processes the address field and any other necessary processing data and dispatches the encrypted data to the closest available Service Destination Agents on Tier 3.

Central Server is the control point, performing system management tasks for the entire system. Among the major functions of the Central Server are:

Database system. The sender's account information, sender's billing information, sender's content format, content and address book, sender and system statistics data, system logs, Service Destination Agent locations and status, routing table and other related data are stored in the Central Server database.

Data collection. This collects the data from Tier 1. The Tier 1A data is uploaded to Central Server, for example through the web site. For Tier 1B, the Central Server monitors the dedicated connection port and accepts the incoming data as soon as it is available on the port.

Dispatch. Central Server parses the incoming data from Tier 1, finds the destination address and other processing data, determines the closest available processing point on Tier 3 based on the destination address and other processing information, and dispatches the data to that processing point.

Multiple Delivery Route Choice. A destination can be reached via different Service Destination Agent locations across Tier 3 if the primary route choice is not available.

Receipt collection. Central Server collects the receipts from Tier 3 and matches them with the incoming content. A confirmation is sent over Tier 1 to the sender once the receipt is received.

Billing. The Central Server manages the billing account of the sender based on such factors as successful deliveries, content and general service utilization as is standard practice.

Host and maintain Tier 1A web site.

Connection Monitor. There are dedicated connections between Central Server and Tier 1B, as well as Central Server and Tier 3. The status of those connections are monitored. An alarm signal is generated if the connection is down.

System administration. General system administration to monitor for example the status, load and processing delay of Service Destination Agents of Tier 3, the status, load and processing delay of Tier 1, and the status, load and processing delay of the Central Server itself.

Tier 3. Service Destination Agent

As shown in FIG. 1, Tier 3 is comprised of two or more Service Destination Agents 2 that accept and interpret data from Tier 2. Multiple Service Destination Agents are geographically distributed throughout a region or the entire world.

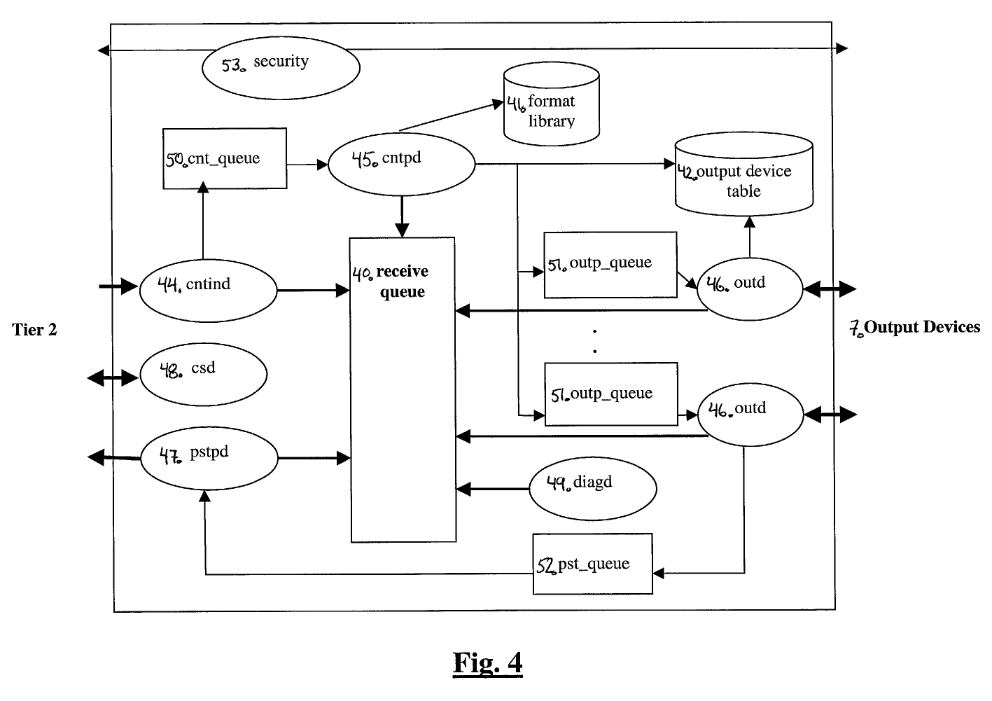

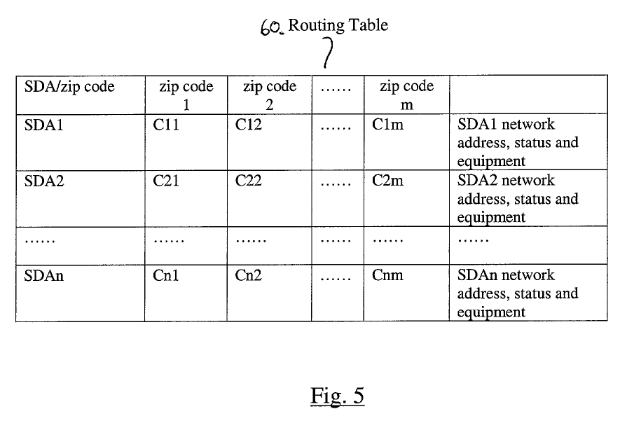

As shown in FIG. 4, the Service Destination Agent undertakes an output procedure based on the mail content and the processing data transmitted from Tier 2. The output procedure may include, for example, the printing, folding, inserting and stamping a unit or units of mail. The Service Destination Agent may have a direct or a network connection to appropriate Output Device 7, such as a printer, a CD-ROM writer, or a similar memory device.

A receipt is sent back to Tier 2 once the procedure is complete. The output material at Tier 3 is then distributed by a neighboring process directly to the recipient or manually by means of a physical delivery system such as by the traditional postal service or commercial courier.

The Service Destination Agent performs maintenance functions. It responds to Tier 2 maintenance data by reporting its status, such as work load, queue and process rate of the Service Destination Agent and the attached output procedures. Service Destination Agent reports its status if it detects any local problem, such as failure of the local output procedures or a local apparatus.

The connection between Tier 2 and the Service Destination Agent is preferably a permanent connection, using connection oriented or connectionless protocols, such that the Service Destination Agent can send content to Service Destination Agent in a timely fashion.

The invention supports various content formats such as plain text, html, MS word, PDF, image, and voice. The content may be distributed electronically and, at Tier 3, take on the intended physical nature in a form other than a traditional letter, such as a memory device (CD or DVD) or an actual physical product (as in a replicator or a three dimensional printer).

The invention supports security features such as a secure socket layer protocol and other standard security elements. For example, the sender's ID and passwords may be required to identify a sender at Tier 1, and authenticate a data file across the system. The sender can enable or disable data encryption so that sensitive data is encrypted during transmission and when it is saved at the Central Server or the Service Destination Agent. The output at the Service Destination Agent may be in a secure environment.

Operation of Invention

The operation of the network-based content collection and distribution system includes a software system at each of the three tiers.

Tier 1—Service Access Point

At the Common Service Access Point 10 the sender accesses the system through a standard Internet web browser, a transmission application, or a similar interface. At the Special Service Access Point 12 the sender accesses the system though a secure transmission application. Through both forms of Service Access Points 2, the sender registers for services and provides the appropriate sender information, chooses the format of the mail content, enters the destination address or selects from a pre-defined address book, and uploads or edits the content and related material such as common forms and saved files.

Tier 2—Central Server

As shown in FIG. 3, the Central Server receives data from Tier 1, parses the data to obtain the recipient's address and related processing data, and determines the closest available processing location at Tier 3 according to the recipient's geographical address or other parameters. The Central Server then forwards the data to this Service Destination Agent. The software system is comprised of database components, processes internal processes and system timers. The software system may include some or all of the following:

A. Database Components

Send Queue

Send queue 20. The data from Service Access Point, including the content, destination address, format and sender, is inserted into this queue, processed by a batch of processes in Tier 2 and eventually delivered to Service Destination Agent from this queue. All or some of these processes can be performed within a kernel or a similar secure environment. Each entry may consist of sequence number, status, format, class of service, original content, formatted content, schedule, retry count, sender, destination, and other characteristics.

Routing Table

The routing table 21 provides information of where the content should be delivered. This maps a geographical address to a network address (e.g. an internet IP address). It may have two parts. One is the Service Destination Agent/zip code cost chart that gives the cost of delivery from a certain Service Destination Agent to a certain zip code. The other is the Service Destination Agent network address, RX/TX ports number, status and equipment description table, which contains the Service Destination Agent availability, load, equipment installed, software version, format supported, and other relevant factors. The table is periodically updated.

Format Library

Format library 22 contains the formats that are supported by the system. It is also the collection of format conversion routines. Processes can consult this library to convert the original content to pre-defined and printable format. The format library may also reside at the Service Access Point or at the Service Destination Agent.

Database

The database 23 resource supports several general database uses. Statistics and billing database track the sender's usage of this service. The billing information can be obtained from the statistical data. Subscriber database contains the individual information for each registered sender of this service. The sender may be identified by, for example, a sender ID and password. The sender is allowed to keep limited amount of content in the archive, which is stored in the content database. This may be sender standard forms, prior or pending content, etc.

B. Processing Units

Most of the internal communication may be performed by using queues, processes and timer. The queue can be implemented by named pipe, file system, database or other recoverable facilities. One process writes the sequence number, which corresponds to the sequence number of one entry in the send queue, to the specific queue. Another process reads the sequence number out of the queue. If the system crashes, the queues will be recovered by an init process.

The system processes and timers include the following:

Web Server

Web Server 26 is actually not a process. Subscriber uploads the content to the Tier 2 through the browser or similar communications medium. This will invoke the Web Server to create a process/thread, such as a CGI program, to process the request. The input data is validated and proper information is download back to sender's browser. The validated input data will be inserted into send queue, with the entry's status set to ‘before pre-process’. The sequence number is written to the prp_queue of FIG. 6.

prpd

pre-process daemon. prpd 27 reads a sequence number from the prp_queue and performs pre-process tasks for the corresponding entry. For example, it may consult the format library to convert the original content to the formatted and printable format. The prpd then checks the schedule of this delivery. If it is an instant delivery, the prpd updates the entry's status to ‘before dispatch’ and writes the sequence number to the dsp_queue. If it is marked for future delivery, the prpd will start a retry timer with this sequence number. The retry timer should time out at the future delivery time.

dispatchd

dispatch daemon. The dispatchd 28 reads a sequence number from dss_queue. Its major job is to determine the specific Service Destination Agent for content delivery by looking up the routing table. The basic algorithm is to choose the available minimum cost Service Destination Agent based on the destination zip code and related information. A retry timer may be set with the sequence number if the selected Service Destination Agent has a heavy process load, is temporarily unavailable, or displays limited performance characteristics. Dispatchd updates the entry's status to ‘before send’ and writes the sequence number to snd_queue.

sndd

send daemon. The sndd 29 reads a sequence number from snd_queue, fetches the corresponding entry from the send queue and transmits to the TX TCP port or similar communications interface. If the transmission is successful, the sndd updates the entry's status to ‘after send’, and then starts a rcpt timer with this sequence number. If it fails to send, a retry timer with the sequence number is initiated.

rcptd

receipt daemon. The rcptd 30 collects receipts returning from the Service Destination Agents. The receipt should bear the original sequence number. The rcptd stops the rcpt timer, matches the receipt with the entry in send queue and updates the entry's status to ‘receipt received’, then writes the sequence number to the pst_queue.

pstpd

post-process daemon. The pstpd 31 reads a sequence number from the pst_queue and finds the entry in the send queue. It may move the content to the content database, update the statistics and billing database to bill the subscriber, send email notification to the subscriber, and finally remove this entry from send queue.

sdad

Service Destination Agent daemon. The sdad 32 is the monitor of the Service Destination Agents connected to the Central Server. The sdad periodically queries the status of Service Destination Agents and collects the Service Destination Agent's status report. It updates the routing table and sends alarms if the Service Destination Agent(s) encounters a system problem. The other function of sdad is to install or upgrade software or data to Service Destination Agents to allow for dynamic maintenance of the system.

diagd

diagnose daemon. The diagd 33 periodically scans the send queue, finding the entries that have delivery trouble, such as an entry that has been retried for a certain number of times or a certain period of time. The diagd generates alarms for those troubled entries. A higher-level process or the system administrator then can trouble-shoot the system. The diagd may also remove the stalled entries and warn a higher-level process or the system administrator of such removal.

Retry Timer

The retry timer 37 can be set by prpd, dispatchd and sndd with the sequence number of an entry in send queue. It schedules a future time to retry the delivery. The retry mechanism is the way that we guarantee that all the content can be delivered correctly. The future delivery is also handled in this manner. The expiration of the retry time will invoke its handle, which writes the sequence number to the dsp_queue provided that the entry is still valid in the send queue.

rcpt Timer

receipt timer. The receipt timer 38 is set by sndd after successfully transmitting one content to Service Destination Agent. The Service Destination Agent should send back receipt confirmation within a specific time, which is the duration of the rcpt timer. If the rcptd receives the receipt from Service Destination Agent it will stop the rcpt timer. The expiration of rcpt timer indicates that the Tier 2 has not received a receipt from Service Destination Agent in this specified time, which implies there could be some trouble with the Service Destination Agent to process the delivery. The handle of rcpt timer is invoked upon the time out. The handle set the entry's status to ‘before dispatch’ and writes sequence number to dsp_queue.

C. Best Method—Flow of Delivery Processing

The best mode of operating the Central Server is the following:

0. The init process is automatically running after the system is up. It initializes the entire system. It first created the internal communication queues and checks the send queue. Based on the status of each entry in send queue it writes the sequence number to corresponding queue, or starts retry timer or rcpt timer. Then the init spawns all the system daemons. The security server is also automatically running after the system comes up. The data transferring between Tier 2 and Service Access Point, Tier 2 and Service Destination Agent may be encrypted

1. Subscriber uploads the content and destination address to Web Server from his/her browser. The Web Server invokes CGI program to process the input data. An error message will be written back to the sender's browser if the input data is invalid, otherwise the successful message will be written back.

2. The web server generates a unique sequence number and inserts the input data to send queue. The entry's status is set to ‘before pre-process’. Then the web server writes the sequence number to prp_queue.

3. The prpd reads sequence number from prp_queue. It is blocked if nothing is in the queue. After getting the sequence number it operates on the corresponding entry in the send queue. It may consult the format library to convert the original content to pre-defined or printable format. The deliver schedule will be checked. If it is instant delivery, the prpd marks the entry's status to ‘before dispatch’ and writes the sequences number to dsp_queue. If it requires future delivery the prpd marks the entry's status to ‘before dispatch’ and starts a retry timer with the sequence number. The handle of retry timer will then write the sequence number to dsp_queue upon time out.

4. Dispatchd reads the sequence number from dsp_queue, and gets the destination address, the zip code from the entry. Then dispatchd look up the routing table for this zip code, based on specific algorithm to choose a Service Destination Agent to deliver the content. If dispatched can't find a proper Service Destination Agent, it starts a retry timer to schedule a future retry. If dispatchd find a Service Destination Agent, it sets the entry's status to ‘before send’ and writes the sequence number to snd_queue.

5. The sndd reads sequence number from snd_queue and fetches the corresponding entry from the send queue. Then sndd finds the IP address and port number of destination Service Destination Agent, and transmits content to the Service Destination Agent's IP/port through the TCP TX port or similar communications interface. If the transmitting successes the sndd updates the entry's status to ‘after send’, and then starts a rcpt timer with the entry's sequence number. If it fails to send, the entry's status is set to ‘before dispatch’ and a retry timer is started. The handle of rcpt timer will then marks the entry's status to ‘before dispatch’ and writes the sequence number to dsp_queue upon the expiration of the timer. The time out of rcpt timer indicates that the Tier 2 hasn't received the receipt from Service Destination Agent in specific period of time and the Service Destination Agent probably has trouble to handle this delivery, re-delivery is necessary.

6. The rcptd waits for the receipt confirmation from Service Destination Agents. The receipt from Service Destination Agent should bear the original sequence number of the content. The rcptd matches the receipt with the entry in send queue with the same sequence number, then updates the entry's status to ‘receipt received’. It also finds the rcpt timer for this entry and stops the timer. Then the rcptd writes the sequence number to pst_queue.

Tier 3

The Service Destination Agent receives data from Tier 2, parses the data to obtain the mail content, recipient's address and related processing data. The Service Destination Agent then processes the digital content into hardcopy form and forwards this to a physical delivery system such at the postal service or a commercial courier. The software system is comprised of database components and internal processes. The software system may include some or all of the following:

Multiple printers, distribution terminals, and other apparatus can be supported by Service Destination Agent. Each printer or apparatus may be associated with one output process and its own device driver or multiple processes and drivers. Similarly, Service Destination Agent supports, and can be dynamically updated to support, multiple software environments to be found in the hardware elements associated with the system.

As shown in FIG. 4, the operation of the Service Destination Agent is detailed by the following.

A. Database Components

Receive Queue

The content data that Service Destination Agent receives from Tier 2 is inserted into the Receive queue 40. The sequence number of the content record is retained the same as in the Tier 2 send queue. The queue is processed by a batch of processes in Service Destination Agent and the content is eventually processed by the printer or other output apparatus. The entry may consist of sequence number, status, format, class of service, original content, formatted content, schedule, retry count, sender, destination, etc.

Format Library

The format library 41 is used to convert the content to the appropriate format if the content format has not been converted by the Central Server.

Output Device Table

The Service Destination Agent can support multiple hardware apparatus and distribution terminals such as a printer or a memory device. For example, the printer information and status are recorded in an output device table 42. The entry of each output device table includes, but is not limited to, the technical specification of the output device, the format it supports, the load status, etc.

B. Internal Service Destination Agent Communication

Most of the internal communication is performed by using queues: cnt_queue 50, outp_queue 51, and pst_queue 52. The queues can be implemented by named pipe, file system, database or other recoverable facilities. One process writes the sequence number, which corresponds to the sequence number of the receive queue, to the specific queue. Another process reads the sequence number out of the queue. If the system crashes, the queues will be recovered by the init process.

C. Processing Units

The system processes include the following:

cntind

content-in daemon. The cntind 44 receives content data from Central Server. The content data is validated and inserted into receive queue, with the entry's status set to ‘before content process’. The sequence number is written to the cnt_queue.

cntpd

content-process daemon. cntpd 45 reads sequence number from the cnt_queue and processes the corresponding entry. It may consult the format library to convert the original content to the formatted content which can be processed by the appropriate output device, if the content hasn't been formatted by Central Server. The cntpd then checks the output table to determine a proper output apparatus, updates the entry's status to ‘before output’, and writes the entry's sequence number to that output's outp_queue

outd

output daemon. The outd 46 reads sequences number from outp_queue. It fetches the content data from receive queue and sends data to the appropriate apparatus that it controls. If the output processing or transmission process is successful, the outd updates the entry's status to ‘after output’, and writes the sequence number to pst_queue. If the output processing or transmission process fails, it updates the entry's status to ‘before content process’ and writes the sequence number back to cnt_queue. The outd also updates the output device's status in output device table.

pstpd

post-process daemon. The pstpd 47 reads sequence number from the pst_queue and finds the entry in the receive queue. It sends a receipt to Tier 2 with the entry's sequence number and finally removes this entry from receive queue.

csd

CS daemon. The csd 48 is the monitor of the Service Destination Agent's connection with Central Server, receiving management and related commands from Central Server. The csd receives a status poll from Tier 2 and sends back its status report to Central Server. It may actively send status reports to Tier 2 if the Service Destination Agent encounters problems or configuration changes. The csd also receives other commands from Central Server, downloading software or data to Service Destination Agent.

diagd

diagnose daemon. The diagd 49 periodically scans the receive queue, finding the entries that have trouble to output or transmit, e.g. an entry that has been stayed for an amount of time. The diagd generates alarms for those troubled entries. A higher-level process or the system administrator then can manually trouble-shoot the system. The diagd may also remove the stalled entries.

E. Best Method—Flow of Delivery Processing

The best mode of operating the Service Destination Agent is the following:

1. The init process is automatically running after the system is up. It initializes the entire system. It first created the named queues and checks the receive queue. Based on the status of each entry in receive queue it writes the sequence number to corresponding queue. Then the init spawns all the system daemons. The security server is also automatically running after the system comes up. So all the data transferring between Tier 2 and Service Destination Agent is encrypted

7. CS sends content data to Service Destination Agent. The content data is received by cntind. The cntind performs some validation. An error message will be written back to Tier 2 if the content data is invalid.

8. The cntind inserts the content data to receive queue, with the sequence number, which is generated by the Tier 2 for the content data, as the unique key. The entry's status is set to ‘before content process’. Then the cntind writes the sequence number to cnt_queue.

9. The cntpd reads sequence number from cnt_queue. It is blocked if nothing is in the queue. After getting the sequence number it operates on the corresponding entry in the receive queue. It may consult the format library to convert the original content to a pre-defined format for the appropriate output device, if the content isn't formatted by Central Server. The cntpd then checks the output device table to choose a proper output device, marks the entry's status to ‘before output’, and writes the entry's sequence number to that output device's outp_queue.

10. The outd reads sequence number from outp_queue and fetches the corresponding entry from the receive queue. The outd then send data to output device it controls. If the output processing is successful, the outd marks the entry's status to ‘after output’, and writes the sequence number to pst_queue. If output processing or transmission fails, it marks the entry's status to ‘before content process’ and writes the sequence number back to cnt_queue. The outd also tracks and updates the output device's status in output table.

11. The pstpd reads sequence number from the pst_queue and finds the entry in the receive queue. The pstpd sends a receipt to Tier 2 with the entry's sequence number and finally removes this entry from receive queue. At this point the content process is considered complete.

12. Though the csd is outside the content process, it is an important daemon in the system. The csd is the monitor of the Service Destination Agent's connection with Central Server, receiving management commands from Central Server. The csd receives status poll from Tier 2 and sends back its status report to Central Server. It may actively sends status report to Tier 2 if the Service Destination Agent encounters problems or configuration changes. The csd also receives other commands from Central Server, downloading software or data to Service Destination Agent.

13. The diagd is also outside the content process. It periodically scans the receive queue, finding the entries that have trouble to process, e.g. an entry that hasn't been processed for a certain period of time. The diagd generates alarms for those troubled entries. A higher-level process or the system administrator then can trouble-shoot the system. The diagd may also remove the stalled entries and warn a higher-level process or the system administrator of such removal.

Description and Operation of Alternative Embodiments

Conclusion

Thus, the invention provides a system by which a sender can distribute mail content across a network system in digital form for processing and presentation to a physical delivery system at a processing location close to the recipient's geographical location:

While the above description contains many specificities, these should not be construed as limitations on the scope of the invention, but rather as an exemplification of on preferred embodiment thereof. Many other variations are possible.

I claim:

1. A method of distributing mail content over a network, comprising the steps of:
providing a Central Server connected to a communications medium capable of receiving digital content and identifying the geographical destination address in said digital content,
providing one or more Service Destination Agents each connected to a communications medium and capable of transforming said digital content into hardcopy content.
receiving digital content through the Central Server,
identifying the geographical destination address in said digital content,
determining the Service Destination Agent closest to the destination address,
receiving digital content through the Central Server,
transforming the digital content into hardcopy content by means of an output device, and
sending said hardcopy content to a physical delivery system;
whereby digital content sent by a sender will be transformed into hardcopy content and distributed to the destination address intended by said sender.

2. The method in claim 1 further comprising the steps of:
providing a Service Access Point connected to a communications medium,
receiving digital content through the Service Access Point,
verifying the identity of said sender, and
sending said digital content to said Central Server.

3. A mail distribution apparatus comprising:
a Central Server connected to a communications medium, and
one or more Service Destination Agents each connected to a communications medium, having a means for receiving digital content at the Central Server, transmitting the digital content to a Service Destination Agent located closest to a destination address contained in the digital content, transforming the digital content into hardcopy form, and sending the hardcopy content to a physical distribution system;
whereby said digital content is transmitted to the destination address in physical form.

4. A routing table that maps a geographical address with a network address.

5. A network distribution method that maps a geographical address with a network address of a Service Destination Agent comprising the steps of:
providing the network address of one or more Service Destination Agents,
providing the geographical location of one or more Service Destination Agents,
providing the geographical location of a destination address, and
mapping the closest network address to the geographical address of the mail content;
whereby the closest Service Destination Agent to a destination address is determined.
